(19) United States
(12) Patent Application Publication
(10) Pub. No.: US 2016/0372907 A1
(43) Pub. Date: Dec. 22, 2016

(54) WIRE HARNESS HAVING FIXING MEMBER

(71) Applicant: SUMITOMO WIRING SYSTEMS, LTD., Mie (JP)

(72) Inventor: Ryo SUENAGA, Mie (JP)

(73) Assignee: SUMITOMO WIRING SYSTEMS, LTD., Mie (JP)

(21) Appl. No.: 15/038,750

(22) PCT Filed: Dec. 5, 2014
(86) PCT No.: PCT/JP2014/082201

§ 371 Date: May 24, 2016

(30) Foreign Application Priority Data
Dec. 12, 2013 (JP) 2013-256818

(51) Int. Cl. H02G 3/32; H01B 7/00

(52) U.S. Cl. CPC H02G 3/32; H01B 7/0045

(57) ABSTRACT

A wire fixating member with band is wound around a wire harness and includes: a vehicle fixation portion capable of fixating to a vehicle; a band fixation portion provided to the vehicle fixation portion and including engagement claws inside a band insertion hole; and a band. The band includes a band main body formed in a strip shape extending from the band fixation portion, the band main body having engagement grooves with which the engagement claws can engage and also being capable of insertion into the band insertion hole; and a position regulating protrusion provided at a position on the band main body separated from a base end of the band main body, the position regulating protrusion regulating insertion displacement of the band main body within the band insertion hole.

### FIELD OF THE INVENTION

The present invention relates to a technology fixating wires or the like to a vehicle.

### BACKGROUND OF THE INVENTION

Patent Literature 1 discloses a wire harness that includes a cable, a plate member arranged along the cable, and a pair of clip bands bundling the cable and plate member. The plate member has an irregular shape, and the pair of clip bands are each fitted into respective portions of the irregular shape. Accordingly, an interval between the pair of clip bands is regulated. In the technology disclosed in Patent Literature 1, the clip bands are tightened around the cable and plate member. Therefore, the clip bands are also believed to be unlikely to displace in a circumference direction of the cable.

### RELATED ART

### Patent Literature

Patent Literature 1: Japanese Patent Laid-open Publication No. 2012-110100

### SUMMARY OF THE INVENTION

### Problems to be Solved by the Invention

When assembling the wire harness into the vehicle, due to the wire harness twisting or the like, in some cases it may be difficult to install a vehicle fixation portion in an appropriate position to insert the vehicle fixation portion toward a fixation hole formed in the vehicle and attach the vehicle fixation portion, and inserting the vehicle fixation portion into the fixation hole and attaching the vehicle fixation portion to the vehicle may be difficult.

A wire fixating member with band may be attached to a wire harness so as to be capable of displacement relative to the wire harness.

A configuration accomplishing this may be a configuration in which a corrugated tube having an interior diameter greater than an exterior diameter of a wire harness sheathes the wire harness, and a member fixating the corrugated tube to a vehicle is fixated to the corrugated tube with adhesive tape or the like (first example). According to this first exemplary configuration, the fixation member can be rotated around the wire harness together with the corrugated tube.

Also, a configuration may be used in which, in a state where a separate iron core lies alongside a wire harness, a wire fixating member with band is wrapped around the wire harness and iron core, after which the iron core is removed, enabling the band to rotate around the wire harness (second example).

However, according to the first example, after the corrugated tube sheathes the exterior of the wire harness, the fixation member must be fixated to the corrugated tube. Therefore, there are a large number of components attached to the wire harness, complicating attachment work.

The second example requires work to wind the band in a state where the iron core lies alongside the wire harness, and work to then remove the iron core, complicating the attachment work.

Given this, the present invention enables, with a simple structure and simple work, a configuration in which a wire fixating member with band is attached to a wire harness in a state capable of displacement relative to the wire harness.

### Means for Solving the Problems

In order to resolve the above-noted circumstances, a first aspect is a wire fixating member with band wound around a wire harness and including: a vehicle fixation portion capable of fixating to a vehicle; a band fixation portion provided to the vehicle fixation portion and including engagement claws inside a band insertion hole; and a band. The band includes a band main body formed in a strip shape extending from the band fixation portion, the band main body having engagement grooves with which the engagement claws can engage and also being capable of insertion into the band insertion hole; and a position regulating protrusion provided at a position on the band main body separated from a base end of the band main body, the position regulating protrusion regulating insertion displacement of the band main body within the band insertion hole.

A second aspect is the wire fixating member with band according to the first aspect, in which the position regulating protrusion is provided at the location separated from the base end of the band to a degree enabling the band to form a ring shape of a circumferential length greater than an outer circumferential length of the wire harness in a state where insertion displacement of the band main body within the band insertion hole is regulated by the position regulating protrusion.

A third aspect is the wire fixating member with band according to the first or second aspect, in which the position regulating protrusion is integrally molded to the band main body.

A fourth aspect is the wire fixating member with band according to the first or second aspect, in which the position regulating protrusion is formed as a separate member from the band main body and is fixated to the band main body at a later time.

A fifth aspect includes a wire harness; and the wire fixating member with band according to any one of the first to fourth aspects attached to the wire harness in a state where the band is wrapped around the wire harness.

### Effect of the Invention

According to the first through fifth aspects, while the band is being inserted into the band insertion hole, insertion displacement of the band main body within the band insertion hole is regulated by the position regulating protrusion, and therefore a circumferential length of the ring shape formed by the band can be defined to be at least a constant length. Also, in a state where the insertion displacement of the band main body is regulated, by configuring the circumferential length of the ring shape formed by the band to be larger than the outer circumferential length of the wire harness, the wire fixating member with band can be attached to the wire harness in a state capable of movement with a simple configuration and simple work.

According to the second aspect, in a state where insertion displacement of the band main body within the band insertion hole is regulated by the position regulating protrusion, the circumferential length of the ring shape formed by the band can be made larger than the outer circumferential length of the wire harness.

According to the third aspect, the location of the position regulating protrusion on the band main body can be more reliably fixed.

According to the fourth aspect, the position regulating protrusion can be fixated to the band main body while adjusting the location of the position regulating protrusion on the band main body.

### BRIEF DESCRIPTION OF THE DRAWINGS

FIG. 1 is a schematic perspective view of a wire harness with fixating member according to an embodiment.

FIG. 2 is a schematic cross-sectional view along a line II-II in FIG. 1.

FIG. 3 is a partial schematic cross-sectional view of the wire harness with fixating member.

FIG. 4 is a lateral view of a wire fixating member with band.

FIG. 5 is a plan view of the wire fixating member with band.

FIG. 6 is an explanatory view of a process of attaching the wire fixating member with band to a wire harness.

FIG. 7 is a plan view of the wire fixating member with band, where a position of a position regulating protrusion is changed.

FIG. 8 illustrates a state where the wire fixating member with band is attached to the wire harness.

FIG. 9 is a plan view of the wire fixating member with band, where the position of the position regulating protrusion is changed.

FIG. 10 illustrates a state where the wire fixating member with band is attached to the wire harness.

FIG. 11 is a lateral view of a wire fixating member with band according to a modified example.

FIG. 12 is a plan view of the wire fixating member with band according to the modified example.

FIG. 13 is a perspective view illustrating a band main body and a position regulating protrusion.

FIG. 14 is a cross-sectional view of a state where the position regulating protrusion is mounted and fixated to the band main body.

FIG. 15 is a perspective view illustrating a band main body and a position regulating protrusion according to another modified example.

### MODE FOR CARRYING OUT THE INVENTION

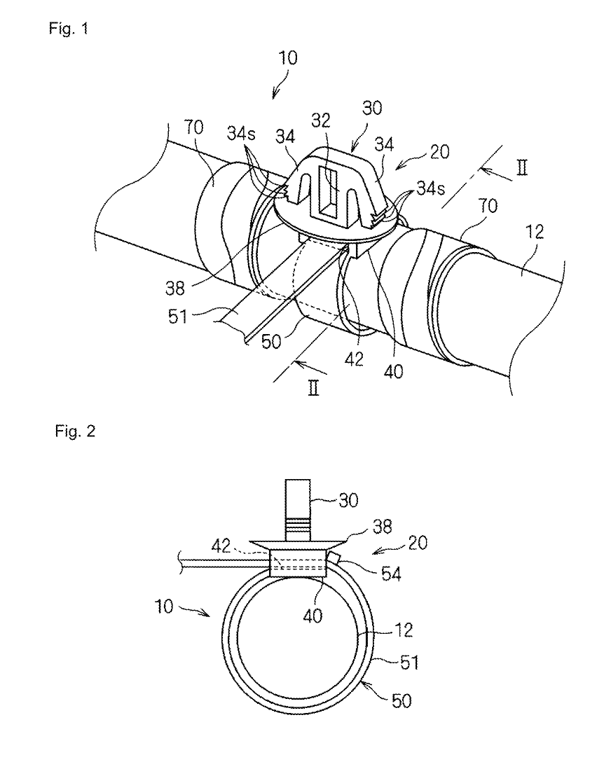

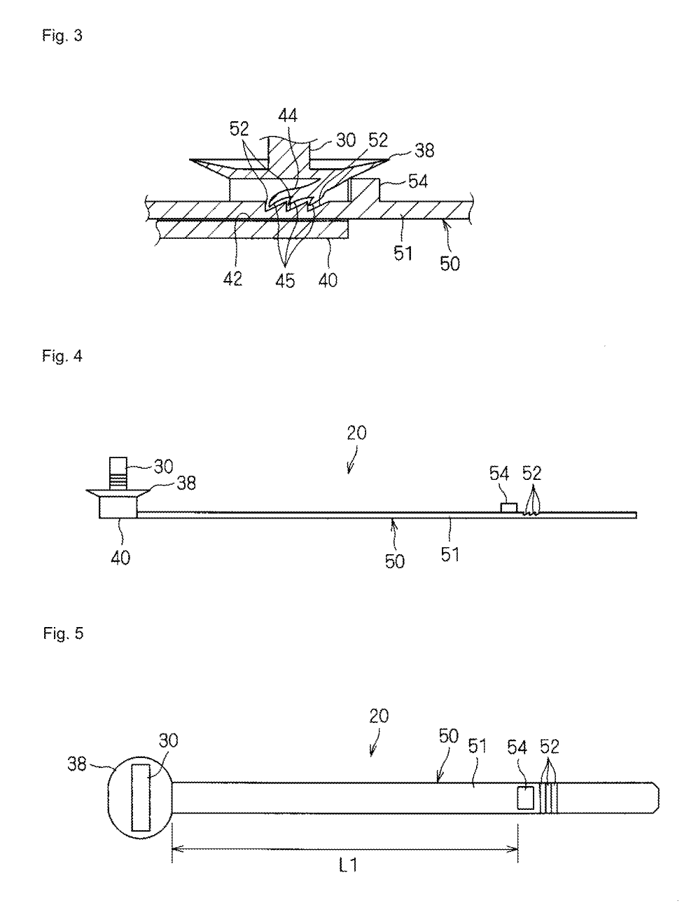

In the following, a wire fixating member with band and a wire harness with fixating member according to an embodiment are described. FIG. 1 is a schematic perspective view of a wire harness with fixating member 10. FIG. 2 is a schematic cross-sectional view along a line II-II in FIG. 1. FIG. 3 is a partial schematic cross-sectional view of the wire harness with fixating member 10. FIG. 4 is a lateral view of a wire fixating member with band 20. FIG. 5 is a plan view of the wire fixating member with band 20. The various drawings provide simplified illustrations of a wire harness 12.

The wire harness with fixating member 10 includes the wire harness 12 and the wire fixating member with band 20.

The wire harness 12 is configured by bundling a plurality of electric wires. The wire harness 12 may be divided into branches as appropriate. In addition, the wire harness 12 may include fiber optic cables and the like.

At an end portion of the wire harness 12, end portions of the wires are connected to connectors or the like. In a state where the wire harness with fixating member 10 is fixated to a vehicle via the wire fixating member with band 20 or the like, by connecting each of the connectors or the like to various electronic components in the vehicle, the various electronic components are electrically connected via the wire harness 12.

The wire fixating member with band 20 includes a vehicle fixation portion 30, a band fixation portion 40, and a band 50. In this example, the wire fixating member with band 20 is a component that is integrally molded by injecting molten resin into a die. The wire fixating member with band 20 may be attached to the wire harness 12 in a state where the band 50 is wrapped around the wire harness 12. In addition, by fixating the vehicle fixation portion 30 to the vehicle, the wire harness 12 can be fixated at a constant position with respect to the vehicle.

The vehicle fixation portion 30 is a portion configured to be capable of fixating to the vehicle. In this example, the vehicle fixation portion 30 is configured to be capable of being inserted and fixated in a fixation hole formed in a panel at an attachment location of the vehicle.

More specifically, the vehicle fixation portion 30 is a portion called a clip or a clamp and includes a pillar 32 and a pair of engagement portions 34 provided to a forefront end of the pillar 32.

The pillar 32 is configured with an elongated portion projecting from the band fixation portion 40. The pair of engagement portions 34 are formed in a shape extending so as to incline outward from the forefront end of the pillar 32 toward a base end. A plurality of step portions 34s, oriented toward the forefront ends, are provided on an outward-facing portion of the forefront ends of the pair of engagement portions 34. In addition, a maximum width of the forefront ends of the pair of engagement portions 34 is configured to be larger than a diameter of the fixation hole (in a case where the fixation hole is oblong, the maximum width is configured to be larger than a major axis of the fixation hole). Also, when inserted into the fixation hole with the vehicle fixation portion 30, the pair of engagement portions 34 abut a circumferential edge of the fixation hole and elastically deform so as to be narrowed. When the pair of engagement portions 34 pass the circumferential edge of the fixation hole, the pair of engagement portions 34 elastically revert to their original shape and one of the steps 34s is retention engaged on the circumferential edge of the fixation hole. This fixates the vehicle fixation portion 30 at a location on the vehicle where the fixation hole is formed.

A plate spring 38 is formed oriented away from the base end portion and toward the forefront end of the pillar 32, and spreads around the circumference of the pillar 32. In a state where the step portions 34s of the pair of engagement portions 34 are engaged with the circumferential edge of the fixation hole, as described above, the plate spring 38 abuts the circumferential edge of the fixation hole, which is the panel at the attachment location, from the opposite side. Accordingly, in a state where the circumferential edge of the fixation hole, which is the panel at the attachment location, is held between the pair of engagement portions 34 and the plate spring 38, the vehicle fixation portion 30 is fixated to the panel at the attachment location.

In addition to the above-described configuration, the vehicle fixation portion may have a configuration in which a bolt or long fixation member (such as a member sometimes referred to as a bracket) provided to a vehicle body is inserted into and fixated to the vehicle fixation portion.

The band fixation portion 40 is provided to the vehicle fixation portion 30 and is configured so as to be capable of fixating the band 50 at a constant position in an extension direction of the band 50.

Specifically, the band fixation portion 40 has a configuration in which a band insertion hole 42 is formed; more specifically, the band fixation portion 40 is formed in a quadrangular cylinder shape and has a configuration in which the band insertion hole 42, having a quadrangular hole shape, is formed in an interior thereof. The band fixation portion 40 is formed such that a band engagement portion 44 projects from one interior circumferential surface of the band insertion hole 42. In this example, the band engagement portion 44 is formed so as to project from an interior circumferential surface of the band insertion hole 42 that is on the vehicle fixation portion 30 side of the band insertion hole 42. The band engagement portion 44 extends from a position closer to an opening on a first end of the band insertion hole 42 while inclining toward an opening on a second end of the band insertion hole 42. In addition, an engagement claw 45 is formed at the forefront end of the band engagement portion 44. In this example, three engagement claws 45 are formed at the forefront end of the band engagement portion 44. Furthermore, each of the engagement claws 45 is formed in the shape of a triangular projection having a surface facing the opening on the first end side of the band insertion hole 42 and a surface facing the opening on the second end side of the band insertion hole 42 (see FIG. 3). The surface of the engagement claw 45 facing the opening on the first end side of the band insertion hole 42 (surface facing right in FIG. 3) and the surface of the engagement claw 45 facing the opening on the second end side of the band insertion hole 42 (surface scooping left in FIG. 3) incline toward the opening at the second end side of the band insertion hole 42 toward the forefront end of each surface, and even when the engagement claws 45 are viewed in totality, the engagement claws 45 are formed in the shape of a triangular projection inclined in a direction toward the opening at the second end side of the band insertion hole 42. When the band 50 is inserted through the opening at the first end side of the band insertion hole 42 toward the opening at the second end side, each of the engagement claws 45 can readily pass over engagement grooves 52 formed in the band 50. In contrast, when the band 50 is pulled back from the opening at the second end side toward the opening at the first end side of the band insertion hole 42, each of the engagement claws 45 catches on the engagement grooves 52 formed in the band 50 and is unlikely to pass over the engagement grooves 52.

The band engagement portion may instead project from an interior circumferential surface of the band insertion hole that is on the opposite side of the band insertion hole from the vehicle fixation portion. Also, the engagement claws may have a shape that projects directly from the interior circumferential surface of the band insertion hole. Moreover, there may be one or a plurality of engagement claws. In order to prevent the band engagement portion 44 from shifting from the band 50, three engagement claws 45 are preferred, as in the present embodiment, but this is not essential.

The band 50 includes a band main body 51 and a position regulating protrusion 54.

The band main body 51 extends farther than the band fixation portion 40, and is also formed in a strip shape capable of being inserted into the band insertion hole 42. A width of the band 50 is configured to be substantially equal to the width of the band insertion hole 42, and is preferably held at as constant a position as possible within the band insertion hole 42. A thickness dimension of the band 50 is configured to be smaller than a height dimension of the band insertion hole 42, and is configured to a size where the engagement claws 45 fit into the engagement grooves 52 in a state where a surface of the band 50 on the opposite side from a surface where the engagement grooves 52 are formed is in contact with the interior circumferential surface of the band insertion hole 42.

In addition, the engagement grooves 52, with which the engagement claws 45 can engage, are formed on the band main body 51. In this example, the engagement grooves 52 are formed at a location where the engagement claws 45 within the band insertion hole 42 can engage in a state where insertion displacement of the band main body 51 within the band insertion hole 42 is regulated by the position regulating protrusion 54.

The number of engagement grooves 52 may be greater than the number of engagement claws 45, and may also be less. In this example, three engagement grooves 52 are provided sequentially, matching the number of engagement claws 45.

Also, in this example, in a state where insertion displacement of the band insertion hole 42 is regulated by the position regulating protrusion 54, the engagement grooves 52 are provided only at locations where the engagement claws 45 within the band insertion hole 42 can engage, and no engagement grooves are provided to locations closer to a base end or a forefront end of the band 50 than these locations.

Each of the engagement grooves 52 are formed in a V-shaped groove extending along a width direction of the band 50. Of the two surfaces of the engagement groove 52, the surface closer to the base end side of the band 50 is inclined so as to grow gradually deeper toward the forefront end of the band 50. The surface closer to the forefront end side of the band 50 extends along the thickness direction of the band 50. Therefore, the engagement claws 45 can pass over the engagement grooves 52 comparatively easily in a direction from the forefront end of the band 50 toward the base end. In contrast, when the engagement claw 45 is oriented from the base end side of the band 50 toward the forefront end side, each of the engagement claws 45 abut the forefront end-side surface of the engagement grooves 52, and therefore have difficulty passing over the engagement grooves 52. Also, due to the engagement grooves 52 having such a shape, when the band 50 is inserted from the opening at the first end side toward the opening at the second end side of the band insertion hole 42, each of the engagement claws 45 can easily pass over the engagement grooves 52 formed in the band 50. In contrast, when the band 50 is pulled back from the opening at the second end side toward the opening at the first end side of the band insertion hole 42, each of the engagement claws 45 catch on the engagement grooves 52 formed in the band 50 and are unlikely to pass over the engagement grooves 52.

The position regulating protrusion 54 is provided at a position on the band main body 51 separated by a distance L1 from the base end portion of the band main body 51.

The position regulating protrusion 54 is formed in a projecting shape capable of regulating displacement of the band main body 51 within the band insertion hole 42. In this example, the position regulating protrusion 54 is formed in a projecting shape capable of abutting the circumferential edge of the opening of the band insertion hole 42. More specifically, the position regulating protrusion 54 is formed in the projecting shape of a rectangular parallelepiped projecting from a primary surface on a side of the band main body 51 where the engagement grooves 52 are formed.

However, the position regulating protrusion may instead project from any portion on an outer circumference of the band. In addition, the projecting shape of the position regulating protrusion may be any other shape, such as a circular column. The position regulating protrusion may also have a configuration regulating displacement of the band main body within the band insertion hole by abutting some other projecting portion or the like formed on the engagement portion 44 or within the band insertion hole.

In the present embodiment, the position regulating protrusion 54 is a portion integrally formed with the band main body 51. However, the position regulating protrusion may instead have a configuration in which the position regulating protrusion is formed separately from the band main body and is later attached to the band main body. Such a modification is described below.

The distance L1 is preferably defined to a size enabling the band 50 to form a ring shape having a circumferential length greater than an outer circumferential length of the wire harness 12 in a state where insertion displacement of the band main body 51 within the band insertion hole 42 is regulated by the position regulating protrusion 54 and the engagement claws 45 are engaged with the engagement grooves 52.

For example, when a configuration is posited in which the insertion displacement of the band main body 51 is regulated by the position regulating protrusion 54 abutting the edge of the opening of the band insertion hole 42, a circumferential length L of the ring shape formed by the band 50 is of a size where a length of the position regulating protrusion 54 in the extension direction of the band main body 51 and an axis direction length of the band insertion hole 42 of the band fixation portion 40 are added to the distance L1. The distance L1 is preferably defined such that this circumferential length L is larger than the outer circumferential length of the wire harness 12.

Also, as described below, a bundling member 70 such as adhesive tape may be wound around both sides of a location on the wire harness 12 where the wire fixating member with band 20 is mounted, and a displacement range of the wire fixating member with band 20 may be regulated in the extension direction of the wire harness 12. In such a case, the circumferential length L of the ring shape formed by the band 50 is preferably defined to be smaller than the outer circumferential length of the bundling member 70.

In view of each of the above circumstances, the circumferential length L of the ring shape formed by the band 50 is preferably a value in which between 5 and 20 mm is added to the outer circumferential length of the wire harness 12.

Ordinarily, in the work of fixating the band 50 to the band fixation portion 40, a band cutting tool may be used to pull the forefront end of the band 50 and cut an excess portion on the forefront end of the band 50. In view of this working length, in a state where the insertion displacement of the band main body 51 is regulated by the position regulating protrusion 54, the band 50 preferably extends slightly (specifically, 3 cm or more) from the band fixation portion 40. The length L1 is preferably defined in consideration of enabling the above-noted excess length portion to exist in addition to the total length of the band 50.

The bundling member 70 such as adhesive tape is wrapped around both sides of a location on the wire harness 12 where the wire fixating member with band 20 is mounted. In a case where adhesive tape is used as the bundling member 70, the adhesive tape is wound around a plurality of times until reaching a thickness where the band 50 does not escape. A bundling band or the like may also be employed as the bundling member.

An example of a manufacturing method of the wire harness with fixating member configured in this way is described.

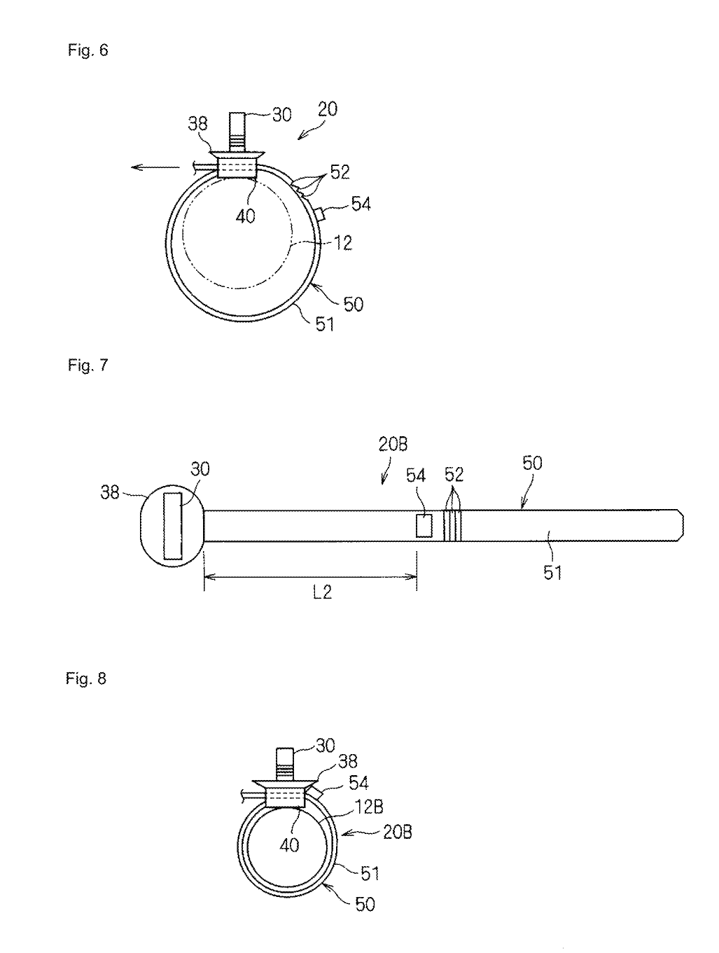

First, as shown in FIG. 6, a plurality of wires are bundled together, the band 50 is wound around the outer circumference of the wire bundle, and the forefront end of the band 50 is inserted through the band insertion hole 42 of the band fixation portion 40. Then, the forefront end of the band 50, which extends from the band insertion hole 42, is pulled.

At this point, the position regulating protrusion 54 abuts the circumferential edge of the opening of the band insertion hole 42. Accordingly, the band 50 (band main body 51) is in a state where the band 50 can be pulled no further. In this state, each of the engagement claws 45 are in a state engaged with the engagement grooves 52 and the band 50 is maintained in a state forming a ring shape having the predetermined circumferential length L.

After this, the forefront end of the band 50 is cut by a blade of a band cutting tool or the like, when necessary. Also, when necessary, the bundling member 70 such as adhesive tape is wrapped around both sides of the wire fixating member with band 20 on the wire harness 12, and the wire harness with fixating member 10 is completed.

According to the wire fixating member with band 20 and the wire harness with fixating member 10 configured as described above, the position regulating protrusion 54 is provided to the band main body 51 at a location separated from the base end of the band main body 51. Therefore, in a state where displacement of the band main body 51 within the band insertion hole 42 is regulated by the position regulating protrusion 54, the circumferential length L of the ring shape formed by the band 50 can be defined to be at least a constant length. For example, in a state where displacement of the band main body 51 within the band insertion hole 42 is regulated by the position regulating protrusion 54, the position regulating protrusion 54 is provided at a location separated by a distance L1 from the base end of the band main body 51, to a degree enabling the band 50 to form the ring shape of circumferential length L, which is greater than the outer circumferential length of the wire harness 12. Accordingly, when the band 50 is pulled so as to be wrapped around the wire harness 12 and fixated to the band fixation portion 40, the band 50 forms a ring shape having the circumferential length L, which is greater than the outer circumferential length of the wire harness 12. Thus, the wire fixating member with band 20 is attached to the wire harness 12 in a state where the wire fixating member with band 20 can move around the outer circumference of the wire harness 12 and can also move in the extension direction of the wire harness 12. Accordingly, with a simple configuration and simple work, and without using a separate corrugated tube or iron core, for example, the wire fixating member with band 20 can be attached to the wire harness 12 in a state capable of movement.

In addition, the position regulating protrusion 54 is integrally molded to the band main body 51, and therefore displacement of the location of the position regulating protrusion 54 on the band main body 51 or the like can be eliminated and the location of the position regulating protrusion 54 can be more reliably fixed. Accordingly, the circumferential length L of the ring shape formed by the band 50 can be more reliably fixed.

{Modifications}

As described above in the embodiment, the position regulating protrusion 54 is formed at a location on the band 50 separated by the predetermined distance L1 from the base end portion of the band 50. The distance L1 is determined in accordance with the outer circumferential length of the wire harness 12.

Given this, the wire fixating member with band 20 may be manufactured according to the outer circumferential length of the wire harness 12 to which the fixating member 20 is to be applied.

For example, in the example shown in FIGS. 7 and 8, a case is posited in which a wire fixating member with band 20B is applied to a wire harness 12B which is smaller than the outer circumferential length of the wire harness 12 posited in the embodiment above.

In such a case, a fixating member in which the position regulating protrusion 54 is formed at a location on the band 50 separated by a predetermined distance L2 from the base end portion of the band 50 is prepared as the wire fixating member with band 20B. The distance L2 is determined in accordance with the outer circumferential length of the wire harness 12B, and is smaller than the distance L1.

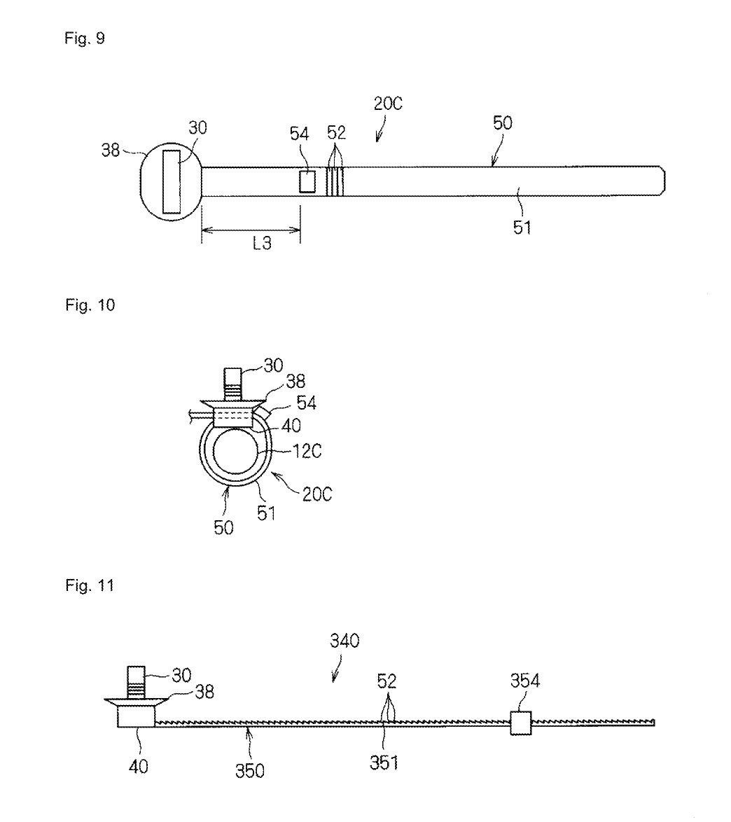

Furthermore, for example, in the example shown in FIGS. 9 and 10, a case is posited in which a wire fixating member with band 20C is applied to a wire harness 12C which is even smaller than the outer circumferential length of the wire harness 12B posited in the example above.

In such a case, a fixating member in which the position regulating protrusion 54 is formed at a location on the band 50 separated by a predetermined distance L3 from the base end portion of the band 50 is prepared as the wire fixating member with band 20C. The distance L3 is determined in accordance with the outer circumferential length of the wire harness 12C, and is smaller than the distances L1 and L2.

Then, for example, when fixating members are prepared having a diameter of 30 mm, a diameter of 20 mm, and a diameter of 10 mm in a state where the band 50 forms a ring shape, it is possible to accommodate the wire harnesses 12, 12B, and 12C, which have various diameters. For example, the band 50 forming a ring shape having the diameter of 30 mm can be applied to a wire harness having a diameter of at least 3 mm and less than 10 mm. The band 50 forming a ring shape having the diameter of 20 mm can be applied to a wire harness having a diameter of at least 10 mm and less than 20 mm. The band 50 forming a ring shape having the diameter of 30 mm can be applied to a wire harness having a diameter of at least 20 mm and less than 30 mm.

Also, in the embodiment described above, an example is given in which the position regulating protrusion 54 is integrally molded on the band main body 51. However, as shown by the modification in FIGS. 11 to 14, a configuration is also possible in which a position regulating protrusion 354 (corresponding to the position regulating protrusion 54) is formed as a separate member from a band main body 351 (corresponding to the band main body 51), and is fixated to the band main body 351 at a later time.

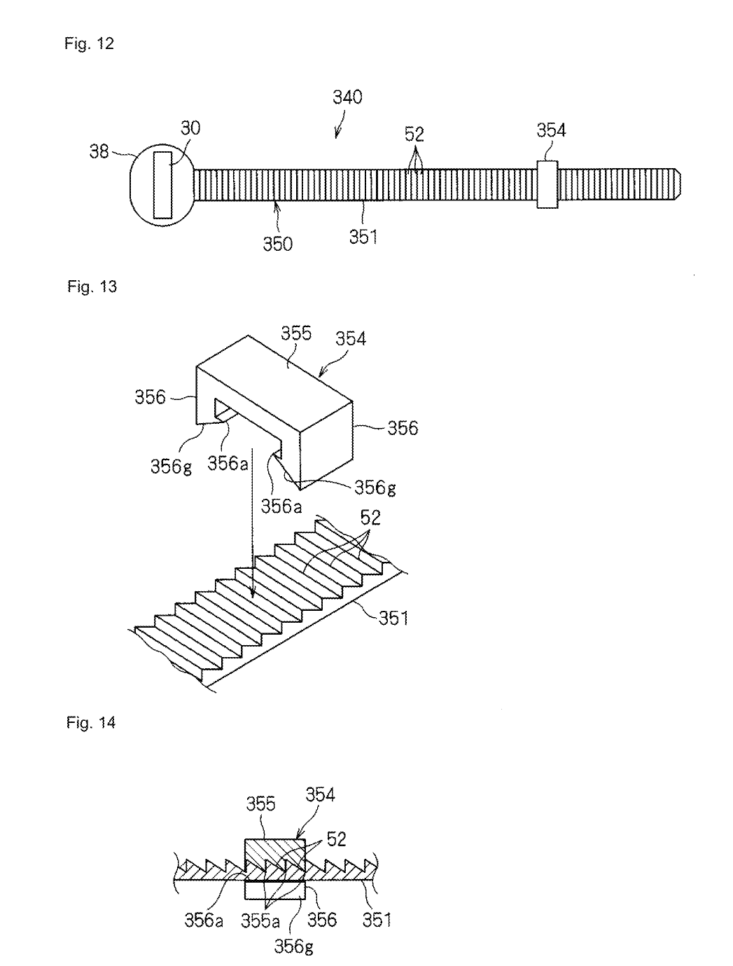

A wire fixating member with band 320 according to the present modification is described. FIG. 11 is a lateral view of the wire fixating member with band 320. FIG. 12 is a plan view of the wire fixating member with band 320.

The wire fixating member with band 320 differs from the wire fixating member with band 20 according to the above-described embodiment in that the wire fixating member with band 320 is a configuration involving a band 350 (corresponding to the band 50).

Specifically, the band 350 includes a band main body 351 and the position regulating protrusion 354.

The engagement grooves 52 are formed along the entire extension direction of the band main body 351. Accordingly, a wire fixating member with band (also called a clip with band, or a clamp with band) having a generic configuration and used conventionally can be used for portions of the wire fixating member with band 320 other than the position regulating protrusion 354.

The position regulating protrusion 354 includes a regulator main body 355 and a pair of side portions 356.

The regulator main body 355 is formed in a shape (in this example, a rectangular plate shape) capable of installation on one main surface of the band main body 351. An engagement projection 355a capable of engaging with the engagement grooves 52 is provided projecting from a portion facing an interior of the regulator main body 355 (see FIG. 14).

In addition, the pair of side portions 356 are formed so as to project in parallel outward from both side portions of the regulator main body 355. Furthermore, the pair of side portions 356 are configured to be capable of accommodating the band main body 351 within a space demarcated by the regulator main body 355 and the pair of side portions 356.

Fixation tabs 356a projecting inward are formed on the forefront ends of the pair of side portions 356. Furthermore, in a state where the band main body 351 is accommodated within the space demarcated by the regulator main body 355 and the pair of side portions 356, the pair of fixation tabs 356a engage with the side portions of the band main body 351 on an opposite side from the regulator main body 355. In addition, in this state, the engagement projections 355a are fitted into the engagement grooves 52 of the band main body 351. Accordingly, in the state where the position is fixed and regulated in the extension direction of the band main body 351, the position regulating protrusion 354 is configured to be fixated with respect to the band main body 351.

Moreover, inclined surfaces 356g inclined inward toward base end sides of the side portions 356 are formed on the forefront ends of the pair of side portions 356, and the band main body 351 can be readily installed between the pair of side portions 356.

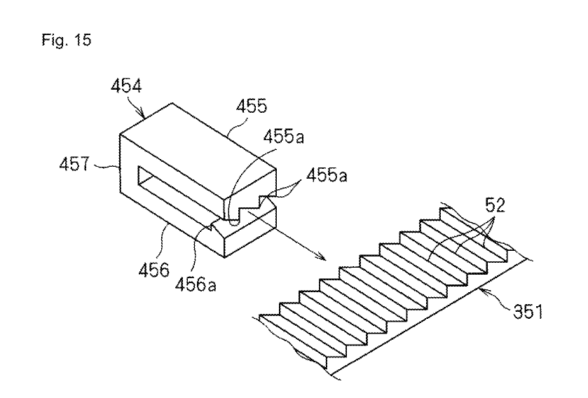

FIG. 15 shows a position regulating protrusion 454 according to another modified example.

The position regulating protrusion 454 includes a pair of pincers 455 and 456, and a coupling tab 457.

The first pincer 455 is formed in a shape (in this example, a rectangular plate shape) capable of installation on a first main surface of the band main body 351, and the second pincer 456 is formed in a shape (in this example, a rectangular plate shape) capable of installation on a second main surface of the band main body 351.

The coupling tab 457 connects and supports the pair of pincers 455 and 456 in a parallel state with a space of approximately the thickness of the band main body 351 between the pair of pincers 455 and 456. Furthermore, the coupling tab 457 is configured to allow the band main body 351 to be accommodated within a space demarcated by the pair of pincers 455 and 456 and the coupling tab 457.

Engagement projections 455a capable of engaging with the engagement grooves 52 are provided projecting from a portion facing an interior of the first pincer 455. A fixation tab 456a projecting inward is formed on the forefront end of the second pincer 456. Furthermore, in a state where the band main body 351 is accommodated within the space demarcated by the pair of pincers 455 and 456 and the coupling tab 457, the fixation tab 456a engages with the side portions of the band main body 351 on an opposite side from the coupling tab 457. In addition, in this state, the engagement projections 455a are fitted into the engagement grooves 52 of the band main body 351. Accordingly, in the state where the position is fixed and regulated in the extension direction of the band main body 351, the position regulating protrusion 454 is configured to be fixated with respect to the band main body 351.

According to these exemplary modifications, the position regulating protrusions 354 and 454 can be fixated to the band main body 351 while adjusting the position of the band main body 351 in the extension direction, enabling the position regulating protrusions 354 and 454 to possess a versatility suitable for attachment to wire harnesses 12 of various diameters.

The position regulating protrusion may also have a configuration in which the position regulating protrusion is bonded to the band main body 351 by an adhesive, welding, or the like.

In the above, the present invention is described in detail. However, the above description is, in all aspects, for exemplary purposes and the present invention is not limited by the description. Numerous modifications not given as examples are understood to be conceivable without departing from the scope of the present invention.

### DESCRIPTION OF REFERENCE NUMERALS

10 Wire harness with fixating member
12, 12B, 12C Wire harness
20, 20B, 20C, 320 Wire fixating member with band
30 Vehicle fixation portion
40 Band fixation portion
42 Band insertion hole
45 Engagement claw
50, 350 Band
51, 351 Band main body
52 Engagement groove
54, 354, 454 Position regulating protrusion
70 Bundling member

1. A wire harness with fixating member comprising:
a wire harness; and
a wire fixating member with band comprising:
a vehicle fixation portion configured for fixation to a vehicle;
a band fixation portion provided to the vehicle fixation portion and including engagement claws inside a band insertion hole; and
a band comprising:
a band main body formed in a strip shape extending from the band fixation portion, the band main body having engagement grooves with which the engagement claws can engage and configured for insertion into the band insertion hole; and
a position regulating protrusion provided at a position on the band main body spaced from a base end of the band main body, the position regulating protrusion regulating insertion displacement of the band main body within the band insertion hole,
wherein the wire fixating member with band is attached to the wire harness in a condition in which insertion displacement of the band main body is regulated by the position regulating protrusion abutting an edge of an opening of the band insertion hole and in which the band is wrapped around the wire harness.

2. The wire harness with fixating member according to claim 1, wherein the position regulating protrusion is spaced from the base end of the band main body to a degree enabling the band to form a ring shape of a circumferential length greater than an outer circumferential length of the wire harness in a condition in which insertion displacement of the band main body within the band insertion hole is regulated by the position regulating protrusion.

3. The wire harness with fixating member according to claim 1, wherein the position regulating protrusion is integrally molded to the band main body.

4. The wire harness with fixating member according to claim 1, wherein the position regulating protrusion is formed as a separate member from the band main body and is fixated to the band main body at a later time.

5. (canceled)

6. The wire harness with fixating member according to claim 2, wherein the position regulating protrusion is integrally molded to the band main body.

7. The wire harness with fixating member according to claim 2, wherein the position regulating protrusion is formed as a separate member from the band main body and is fixated to the band main body at a later time.
